(19) United States
(12) Patent Application Publication
(10) Pub. No.: US 2023/0316256 A1
(43) Pub. Date: Oct. 5, 2023

(54) METHOD AND SYSTEM FOR ENABLING COMMUNICATION BETWEEN ELECTRONIC DEVICES USING A PRINTER APPLICATION

(71) Applicant: INNOVITI PAYMENT SOLUTIONS PRIVATE LIMITED, Halasuru Bangalore, Karnataka (IN)

(72) Inventor: Rajeev AGRAWAL, Bangalore, Karnataka (IN)

(21) Appl. No.: 18/041,135

(22) PCT Filed: Aug. 11, 2021
(86) PCT No.: PCT/IB2021/057400

§ 371 Date: Feb. 9, 2023

(30) Foreign Application Priority Data
Aug. 11, 2020 (IN) 202041005879

(51) Int. Cl. G06Q 20/32; G06Q 20/20; H04W 76/14

(52) U.S. Cl. CPC G06Q 20/326; G06Q 20/202; H04W 76/14

(57) ABSTRACT

The present invention discloses a method and a system for enabling communication between electronic devices using a printer application. The method comprising detecting a connection with a second electronic device, wherein the connection is detected by a printer application installed in a first electronic device. Thereafter, the method comprising determining a device identifier of the second electronic device when the second electronic device is connected to the first electronic device. Subsequently, the method comprising configuring the first electronic device to be in a host mode and the second electronic device to be in an accessory mode when the device identifier of the second electronic device matches with a device identifier list of the printer application. Lastly, the method comprising sending an Android Open Accessory command to the second electronic device for enabling communication between the first electronic device and the second electronic device.

### TECHNICAL FIELD

The present subject matter is generally related to the field of data communication, more particularly, but not exclusively, to a method and a system for enabling communication between electronic devices using a printer application.

### BACKGROUND

For payment of any purchases at a shop, typically, Point-Of-Sale (POS) terminal is used to carry out the transaction. The POS terminal receives charge slip such as a sales receipt, an invoice or other documentation from a billing application installed on a computer system at the shop. The communication between the computer system installed with the billing application and the POS terminal may be established without any integration (software and/or hardware) changes either in the billing application or the POS terminal when the billing application and the POS terminal are from a same vendor or party. However, if the billing application and the POS terminal are from different vendors or parties, then significant integration (software and/or hardware) changes either in the billing application or/and the POS terminal may be required. In this situation, one vendor producing the billing application and/or another vendor producing the POS terminal may oppose any significant integration changes to their (software and/or hardware) as this may result in their billing application and/or POS terminal security being compromised. Hence, there is a need for a solution in the payment industry that enables communication between electronic devices such as a computer system installed with a billing application and a POS terminal from different vendors or parties.

The information disclosed in this background of the disclosure section is for enhancement of understanding of the general background of the invention and should not be taken as an acknowledgement or any form of suggestion that this information forms the prior art already known to a person skilled in the art.

### SUMMARY

In an embodiment, the present disclosure relates to a method for enabling communication between electronic devices using a printer application. The method includes detecting a connection with a second electronic device, wherein the connection is detected by a printer application installed in a first electronic device. Thereafter, the method comprising determining a device identifier of the second electronic device when the second electronic device is connected to the first electronic device. Subsequently, the method comprising configuring the first electronic device to be in a host mode and the second electronic device to be in an accessory mode when the device identifier of the second electronic device matches with a device identifier list of the printer application. Lastly, the method comprising sending an Android Open Accessory (AOA) command to the second electronic device for enabling communication between the first electronic device and the second electronic device.

In an embodiment, the present disclosure relates to a system for enabling communication between electronic devices using a printer application. The system includes a first electronic device and a second electronic device, wherein a printer application is installed in the first electronic device. The printer application in the first electronic device is configured to detect a connection with a second electronic device, wherein the connection is detected by a printer application installed in the first electronic device. Thereafter, the printer application in the first electronic device is configured to determine a device identifier of the second electronic device when the second electronic device is connected to the first electronic device. In the subsequent step, the printer application in the first electronic device is configured to configure the first electronic device to be in a host mode and the second electronic device to be in an accessory mode when the device identifier of the second electronic device matches with a device identifier list of the printer application. Lastly, the printer application in the first electronic device is configured to send an Android Open Accessory (AOA) command to the second electronic device for enabling communication between the first electronic device and the second electronic device.

Embodiments of the disclosure according to the above-described method and system may bring about several advantages.

In present disclosure, use of printer application in the first electronic device for enabling communication between the first electronic device and the second electronic device requires minimum or no integration changes in a billing application (from one vendor/party) installed in the first electronic device and/or in the second electronic device i.e., POS terminal (from another vendor/party). As a consequence, the present disclosure works with any type of vendors/parties providing billing application and/or POS terminals, thereby, allowing seamless integration for transactions, especially for payment industry.

Since use of printer application in the first electronic device requires minimum or no integration changes to a billing application installed in the first electronic device, the amount generated by the billing application will be used for payment at the second electronic device i.e., POS terminal. As a result, this approach prevents any possibility of bill amount tampering either in the billing application installed in the first electronic device or in the second electronic device i.e., POS terminal, making, this approach tamper-proof, which is an essential requirement in the payment industry.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1 illustrates an exemplary system for enabling communication between electronic devices using a printer application in accordance with some embodiments of the present disclosure.

FIG. 2 illustrates a flowchart showing a method for enabling communication between electronic devices using a printer application in accordance with some embodiments of present disclosure.

FIG. 3 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

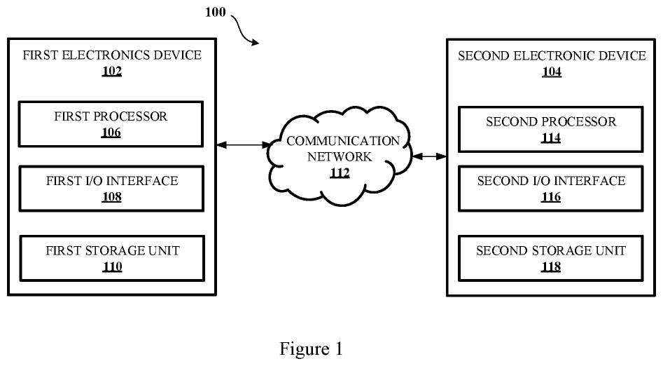

FIG. 1 illustrates an exemplary system for enabling communication between electronic devices using a printer application in accordance with some embodiments of the present disclosure.

As shown in the FIG. 1, the system 100 includes a first electronic device 102, a second electronic device 104 and a communication network 112. The first electronic device 102 may be a computer or a laptop and may be a Windows Operating System (OS) based device. In detail, the first electronic device 102 may be an electronic device with a Window OS. In one embodiment, the first electronic device 102 may be installed with a printer application. The printer application may, also, be referred as a printer interface or a printer driver. In detail, the printer application is a PostScript (PS) printer type application. The printer application has a hook function that captures PS file from a billing application installed in the first electronic device 102 and converts the PS file to text or bitmap file format to send to the second electronic device 104. The first electronic device 102 may include a first processor 106, a first Input/Output (I/O) interface 108 and a first storage unit (also, referred as first memory) 110. In one embodiment, the first I/O interface 108 may be configured to communicate (or communicatively coupled) with the second electronic device 104 using a Universal Serial Bus (USB) cable. Alternatively, the first I/O interface 108 may employ communication protocols/methods such as audio, analog, digital, monoaural, Radio Corporation of America (RCA) connector, stereo, IEEE®-1394 high speed serial bus, serial bus, infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11b/g/n/x, Bluetooth, cellular e.g., Code-Division Multiple Access (CDMA), High-Speed Packet Access (HSPA+), Global System for Mobile communications (GSM®), Long-Term Evolution (LTE®), Worldwide interoperability for Microwave access (WiMax®), or the like with a second I/O interface 116 of the second electronic device 104. The first processor 106 may include at least one data processor for enabling communication between the first electronic device 102 and the second electronic device 104 using the printer application installed in the first electronic device 102. The first processor 106 may include specialized processing units such as integrated system (bus) controllers, memory management control units, floating point units, graphics processing units, digital signal processing units, etc. The first storage unit 110 may store a device identifier list of the printer application. The device identifier list may comprise a list of device identifiers of devices registered/recognized by the printer application. The device identifier may comprise of Product Identifier (PID) and Vendor Identifier (VID) of a device. Additionally, the first storage unit 110 may store temporary data and temporary files generated by the first processor 106 for performing the various functions of the first processor 106

The second electronic device 104 may be any electronic device that allows processing of card payments at shops or retail locations. The second electronic device 104 may be an Android device. In detail, the second electronic device 104 may be a POS terminal. The second electronic device 104 may include a second processor 114, the second I/O interface 116 and a second storage unit (also, referred as second memory) 118. In one embodiment, the second I/O interface 116 may be configured to communicate (or communicatively coupled) with the first electronic device 102 using the USB cable. The second processor 114 may include at least one data processor for enabling communication between the second electronic device 104 and the first electronic device 102 using the printer application installed in the first electronic device 102. The second processor 1114 may include specialized processing units such as integrated system (bus) controllers, memory management control units, floating point units, graphics processing units, digital signal processing units, etc. The second storage unit 118 may store a device identifier of the second electronic device 104. In this case, the device identifier may comprise of PID and VID of the second electronic device 104. Additionally, the second storage unit 118 may store temporary data and temporary files generated by the second processor 114 for performing the various functions of the second processor 114.

Hereafter, the operation of the system 100 for enabling communication between electronic devices (i.e., the first electronic device 102 and the second electronic device 104) using the printer application installed in the first electronic device 102 is described. The first electronic device 102 is a Windows OS based device whereas the second electronic device is an Android device and a POS terminal.

Prior to using the first electronic device 102 and the second electronic device 104 for communication, the first electronic device 102 is installed with the printer application. When the second electronic device 104 is physically connected to the first electronic device 102 using the USB cable, the printer application installed in the first electronic device 102 detects the connection with the second electronic device 104. In detail, libusb, an open source library that allows communication with USB devices, at the second electronic device 104 provides a callback when the second electronic device 104 is connected to or disconnected from the first electronic device 102. In the callback, the first electronic device 102 receives the device identifier of the second electronic device 104. Thereafter, when the second electronic device 104 is connected to the first electronic device 102, the printer application in the first electronic device 102 determines the device identifier of the second electronic device 104. The device identifier comprises of PID and VID of the second electronic device 104. The printer application in the first electronic device 102 compares the device identifier of the second electronic device 104 with the device identifier list of the printer application in the first electronic 102. When the device identifier i.e., the PID and VID of the second electronic device 104 matches with the device identifier list of the printer application in the first electronic device 102, the printer application in the first electronic device 102 configures the first electronic device 102 to be in a host mode (also, referred as a USB host mode) and the second electronic device 104 to be in an accessory mode (also, referred as a USB device mode). The first electronic device 102 in the host mode powers the USB bus (cable) and lists the second electronic device 104 that is connected with the first electronic device 102 in the host mode. In the next step, the printer application in the first electronic device 102 sends an Android Open Accessory (AOA) command to the second electronic device 104 for enabling communication between the first electronic device 102 and the second electronic device 104. Thereafter, when a user gives a command on the first electronic device 102 to send charge slip such as a sales receipt, an invoice, a file or other documentation from a merchant billing application installed on the first electronic device 102 to the second electronic device 104, the printer application in the first electronic device 102 receives the charge slip from the merchant billing application and sends the charge slip to the second electronic device 104. In detail, the printer application installed in the first electronic device 102 is a PS printer type application. The printer application has a hook function that captures PS file of the charge slip such as a sales receipt, an invoice, a file or other documentation from the merchant billing application installed in the first electronic device 102 and converts the PS file of the charge slip to text or bitmap file format to send to the second electronic device 104. Thereafter, the printer application installed in the first electronic device 102 sends the text or bitmap file of the charge slip to the second electronic device 104.

When the device identifier of the second electronic device 104 does not match with the device identifier list of the printer application in the first electronic device 102, the printer application in the first electronic device 102 sends a message to the first processor 106 to alert the user about the mismatch between the device identifier of the second electronic device 104 and the device identifier list of the printer application. In this situation, the printer application in the first electronic device 102 does not configure the first electronic device 102 to be in a host mode and the second electronic device 104 to be in an accessory mode.

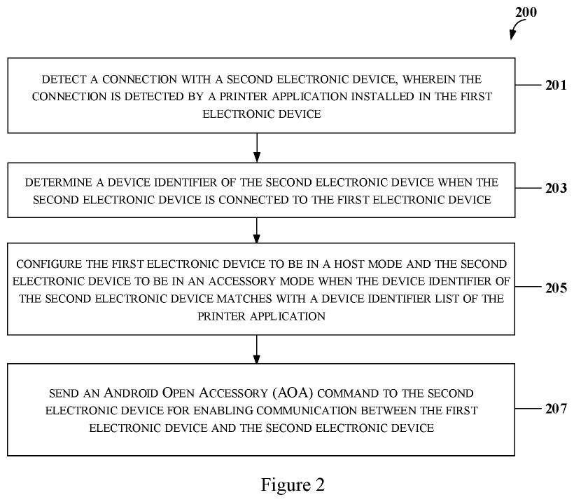

FIG. 2 illustrates a flowchart showing a method for enabling communication between electronic devices using a printer application in accordance with some embodiments of present disclosure.

As illustrated in FIG. 2, the method 200 includes one or more blocks for enabling communication between electronic devices using a printer application. The method 200 may be described in the general context of computer executable instructions. Generally, computer executable instructions can include routines, programs, objects, components, data structures, procedures, modules, and functions, which perform particular functions or implement particular abstract data types.

The order in which the method 200 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 201, the first electronic device 102 may detect a connection with the second electronic device 104. The connection may be detected by a printer application installed in the first electronic device 102. The second electronic device 104 may be an Android device. The first electronic device 102 may be an electronic device with a Window OS. The second electronic device 104 may be a POS terminal. The first electronic device 102 and the second electronic device 104 may be communicatively coupled using a USB cable.

At block 203, the printer application in the first electronic device 102 may determine a device identifier of the second electronic device 104 when the second electronic device 104 is connected to the first electronic device 102. The device identifier may comprise of PID and VID.

At block 205, the printer application in the first electronic device 102 may configure the first electronic device 102 to be in a host mode and the second electronic device 104 to be in an accessory mode when the device identifier of the second electronic device 104 matches with a device identifier list of the printer application.

At block 207, the printer application in the first electronic device 102 may send an Android Open Accessory (AOA) command to the second electronic device 104 for enabling communication between the first electronic device 102 and the second electronic device 104.

Some of the technical advantages of the present disclosure are listed below.

In present disclosure, use of printer application in the first electronic device for enabling communication between the first electronic device and the second electronic device requires minimum or no integration changes in a billing application (from one vendor/party) installed in the first electronic device and/or in the second electronic device i.e., POS terminal (from another vendor/party). As a consequence, the present disclosure works with any type of vendors/parties providing billing application and/or POS terminals, thereby, allowing seamless integration with existing systems for transactions, especially for payment industry.

Since use of printer application in the first electronic device requires minimum or no integration changes to a billing application installed in the first electronic device, the amount generated by the billing application will be used for payment at the second electronic device i.e., POS terminal. As a result, this approach prevents any possibility of bill amount tampering either in the billing application installed in the first electronic device or in the second electronic device i.e., POS terminal, making, this approach tamper-proof, which is an essential requirement in the payment industry.

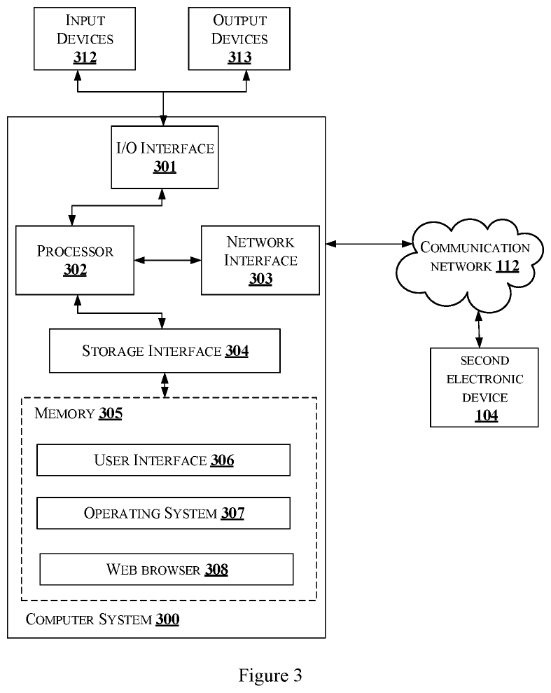

FIG. 3 illustrates a block diagram of an exemplary computer system 300 for implementing embodiments consistent with the present disclosure. In an embodiment, the computer system 300 may be used to implement the first electronic device 102 with a printer application installed. The computer system 300 may include a central processing unit (“CPU” or “processor”) 302. The processor 302 may include at least one data processor for enabling communication between electronic devices using a printer application. The processor 302 may include specialized processing units such as, integrated system (bus) controllers, memory management control units, floating point units, graphics processing units, digital signal processing units, etc.

The processor 302 may be disposed in communication with one or more input/output (I/O) devices (not shown) via I/O interface 301. The I/O interface 301 employ communication protocols/methods such as, without limitation, audio, analog, digital, monoaural, Radio Corporation of America (RCA) connector, stereo, IEEE®-1394 high speed serial bus, serial bus, Universal Serial Bus (USB), infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11b/g/n/x, Bluetooth, cellular e.g., Code-Division Multiple Access (CDMA), High-Speed Packet Access (HSPA+), Global System for Mobile communications (GSM®), Long-Term Evolution (LTE®), Worldwide interoperability for Microwave access (WiMax®), or the like.

Using the I/O interface 301, the computer system 300 may communicate with one or more I/O devices such as input devices 312 and output devices 313. For example, the input devices 312 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 313 may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

In some embodiments, the computer system 300 consists of the first electronic device 102 with a printer application installed. The processor 302 may be disposed in communication with the communication network 112 via a network interface 303. The network interface 303 may communicate with the communication network 112. The network interface 303 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc. The communication network 112 may include, without limitation, a direct interconnection, Local Area Network (LAN), Wide Area Network (WAN), wireless network (e.g., using Wireless Application Protocol), the Internet, etc. Using the network interface 303 and the communication network 112, the computer system 300 may communicate with the second electronic device 104. The network interface 303 may employ connection protocols include, but not limited to, direct connect, Ethernet (e.g., twisted pair 10/100/1000 Base T), Transmission Control Protocol/Internet Protocol (TCP/IP), token ring, IEEE® 802.11a/b/g/n/x, etc.

The communication network 112 includes, but is not limited to, a direct interconnection, a Peer to Peer (P2P) network, Local Area Network (LAN), Wide Area Network (WAN), wireless network (e.g., using Wireless Application Protocol), the Internet, Wi-Fi and such.

In some embodiments, the processor 302 may be disposed in communication with a memory 305 (e.g., RAM, ROM, etc. not shown in FIG. 3) via a storage interface 304. The storage interface 304 may connect to memory 305 including, without limitation, memory drives, removable disc drives, etc., employing connection protocols such as, Serial Advanced Technology Attachment (SATA), Integrated Drive Electronics (IDE), IEEE®-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 305 may store a collection of program or database components, including, without limitation, user interface 306, an operating system 307, etc. In some embodiments, computer system 300 may store user/application data, such as, the data, variables, records, etc., as described in this disclosure. Such databases may be implemented as fault-tolerant, relational, scalable, secure databases such as Oracle or Sybase.

The operating system 307 may facilitate resource management and operation of the computer system 300. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like.

In some embodiments, the computer system 300 may implement web browser 308 stored program components. Web browser 308 may be a hypertext viewing application, such as MICROSOFT® INTERNET EXPLORER®, GOOGLE™ CHROME′, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 308 may utilize facilities such as AJAX, DHTML, ADOBE® FLASH®, JAVASCRIPT®, JAVA®, Application Programming Interfaces (APIs), etc. The computer system 300 may implement a mail server (not shown in FIG. 3) stored program component. The mail server may be an Internet mail server such as Microsoft Exchange, or the like. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. The computer system 300 may implement a mail client (not shown in FIG. 3) stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 2 show certain events occurring in a certain order. In alternative embodiments, certain operations may be performed in a different order, modified or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

REFERRAL NUMERALS:

| Reference number | Description |
|---|---|
| 100 | System |
| 102 | First electronic device |
| 104 | Second electronic device |
| 106 | First processor |
| 108 | First I/O interface |
| 110 | First storage unit |
| 112 | Communication network |
| 114 | Second processor |
| 116 | Second I/O interface |
| 118 | Second storage unit |
| 300 | Computer system |
| 301 | I/O interface |
| 302 | Processor |
| 303 | Network interface |
| 304 | Storage interface |
| 305 | Memory |
| 306 | User interface |
| 307 | Operating system |
| 308 | Web browser |
| 312 | Input devices |
| 313 | Output devices |

We claim:

1. A method for enabling communication between electronic devices using a printer application, the method comprising:
detecting, by a first electronic device, a connection with a second electronic device, wherein the connection is detected by a printer application installed in the first electronic device;
determining, by the printer application in the first electronic device, a device identifier of the second electronic device when the second electronic device is connected to the first electronic device;
configuring, by the printer application in the first electronic device, the first electronic device to be in a host mode and the second electronic device to be in an accessory mode when the device identifier of the second electronic device matches with a device identifier list of the printer application; and
sending, by the printer application in the first electronic device, an Android Open Accessory (AOA) command to the second electronic device for enabling communication between the first electronic device and the second electronic device.

2. The method as claimed in claim 1, wherein the second electronic device is an Android device.

3. The method as claimed in claim 1, wherein the first electronic device is an electronic device with a Window Operating System.

4. The method as claimed in claim 1, wherein the second electronic device is a Point-Of-Sale terminal.

5. The method as claimed in claim 1, wherein the first electronic device and the second electronic device are communicatively coupled using a Universal Serial Bus cable.

6. The method as claimed in claim 1, wherein sending the AOA command to the second electronic device further comprises:
receiving, by the printer application in the first electronic device, one of a file or an invoice from a merchant billing application installed on the first electronic device; and
sending, by the printer application in the first electronic device, one of the file or the invoice to the second electronic device.

7. The method as claimed in claim 1, wherein the device identifier comprises of Product Identifier (PID) and Vendor Identifier (VID).

8. A system for enabling communication between electronic devices using a printer application, the system comprising:
a first electronic device, wherein a printer application is installed in the first electronic device;
a second electronic device;
wherein the printer application in the first electronic device is configured to:
detect a connection with a second electronic device, wherein the connection is detected by a printer application installed in the first electronic device;
determine a device identifier of the second electronic device when the second electronic device is connected to the first electronic device;
configure the first electronic device to be in a host mode and the second electronic device to be in an accessory mode when the device identifier of the second electronic device matches with a device identifier list of the printer application; and
send an Android Open Accessory (AOA) command to the second electronic device for enabling communication between the first electronic device and the second electronic device.

9. The system as claimed in claim 8, wherein the second electronic device is an Android device.

10. The system as claimed in claim 8, wherein the first electronic device is an electronic device with a Window Operating System.

11. The system as claimed in claim 8, wherein the second electronic device is a Point-Of-Sale terminal.

12. The system as claimed in claim 8, wherein the first electronic device and the second electronic device are communicatively coupled using a Universal Serial Bus cable.

13. The system as claimed in claim 8 is configured to:
receive one of a file or an invoice from a merchant billing application installed on the first electronic device; and
send one of the file or the invoice to the second electronic device.

14. The system as claimed in claim 8, wherein the device identifier comprises of Product Identifier (PID) and Vendor Identifier (VID).
